(19) United States
(12) Patent Application Publication
(10) Pub. No.: US 2014/0101189 A1
(43) Pub. Date: Apr. 10, 2014

(54) USING CALENDAR EVENTS TO MODIFY NOTIFICATION AND ALERT BEHAVIOR, SYSTEM AND METHOD

(71) Applicant: EuroSmartz Ltd., Auckland (NZ)

(72) Inventor: Martin R. Schenkel, Auckland (NZ)

(21) Appl. No.: 13/799,411

(22) Filed: Mar. 13, 2013

Related U.S. Application Data
(60) Provisional application No. 61/709,349, filed on Oct. 4, 2012.

(51) Int. Cl. G06F 17/30

(52) U.S. Cl. CPC G06F 17/30386
USPC 707/758

(57) ABSTRACT

A system configured to receive and modify notifications based on calendar events and user-defined rules. The system includes a server that implements a calendar event modification module. The module performs a method that includes receiving search criteria associated with an action. The action instructs the server to either ignore notifications intended for a user device, or modify such notifications before forwarding them to the user device. The action is performed when a notification intended for the user device is received while any calendar events that satisfy the search criteria are occurring.

### CROSS REFERENCE TO RELATED APPLICATION(S)

This application claims the benefit of U.S. Provisional Application No. 61/709,349, filed on Oct. 4, 2012, which is incorporated herein by reference in its entirety.

### BACKGROUND OF THE INVENTION

1. Field of the Invention

The present invention is directed generally to systems and methods for providing notifications to users over a network.

2. Description of the Related Art

Notifications and alerts (hereafter referred to as “notifications”) are data, short messages, instructions to display dialog boxes, and/or instructions to play sounds sent to user computing devices that provide information about the occurrence of events. Examples of events include the receipt of new emails, the posting of new messages (e.g., to a website like TWITTER), the receipt of Rich Site Summary (“RSS”) feed updates, the receipt of text messages, the missing of a telephone call, etc. Unfortunately, notifications received by a mobile device can be particularly disruptive when, in response to receiving the notifications during meetings or other scheduled calendar events, the mobile device generates a display, vibrates, and/or plays one or more sounds. Therefore, a need exists for methods and systems that render notifications less disruptive. The present application provides these and other advantages as will be apparent from the following detailed description and accompanying figures.

### BRIEF DESCRIPTION OF THE SEVERAL VIEWS OF THE DRAWING(S)

FIG. 1 is a diagram of a system configured to modify notifications based on calendar events and user-defined rules.

FIG. 2 is a diagram illustrating information flow through the system of FIG. 1.

FIG. 3 depicts an exemplary email account screen generated by an email notification application.

FIG. 4 depicts an exemplary calendar events screen generated by a calendar application.

FIG. 5 is a flow diagram of a method of creating and storing time-based actions.

FIG. 6A depicts a first exemplary user-defined rule.

FIG. 6B depicts an exemplary format for a data structure configured to store a user-defined rule.

FIG. 7A depicts an exemplary time-based action.

FIG. 7B depicts an exemplary format for a data structure configured to store a time-based action.

FIG. 8A is a flow diagram of a method of using time-based actions to process notifications.

FIG. 8B is a flow diagram of a method of receiving and storing user-defined rules.

FIG. 8C is a flow diagram of a method of using user-defined rules and calendar events to process notifications.

FIG. 9 is a flow diagram illustrating an exemplary order in which a plurality of exemplary user interface screens may be displayed and used to create the user-defined rules for email notifications.

FIG. 10 depicts an exemplary email notifications screen.

FIG. 11 depicts an exemplary calendar actions screen.

FIG. 12 depicts a second exemplary user-defined rule.

FIG. 13 depicts a pair of exemplary time-based actions.

FIG. 14 depicts an exemplary matching events screen.

FIG. 15 depicts an exemplary edit filter screen.

FIG. 16 depicts an exemplary choose field screen.

FIG. 17 depicts an exemplary comparison screen.

FIG. 18 depicts an exemplary choose action screen.

FIG. 19 is a diagram of hardware and an operating environment in conjunction with which implementations of the computing devices and network of the system of FIG. 1 may be practiced.

### DETAILED DESCRIPTION OF THE INVENTION

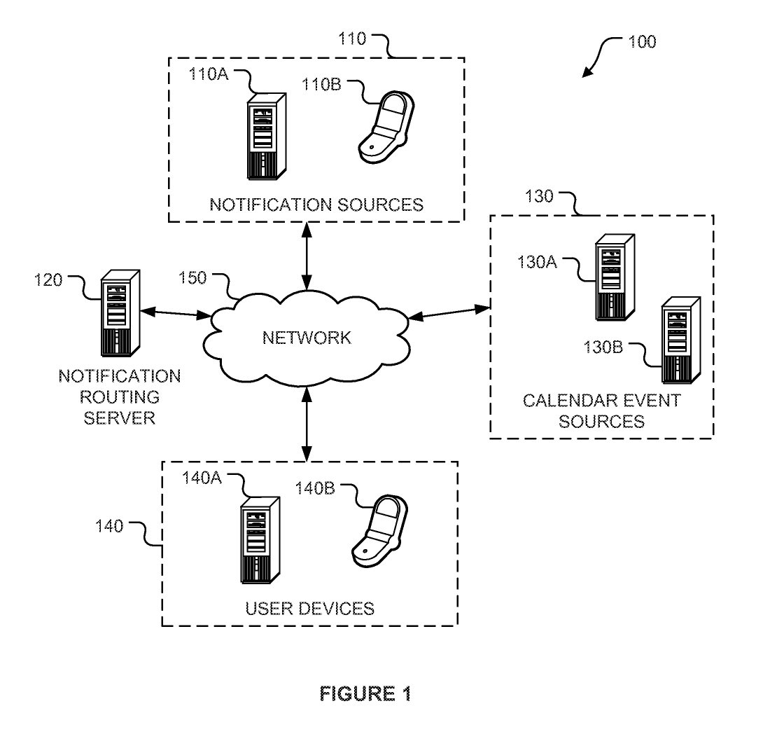

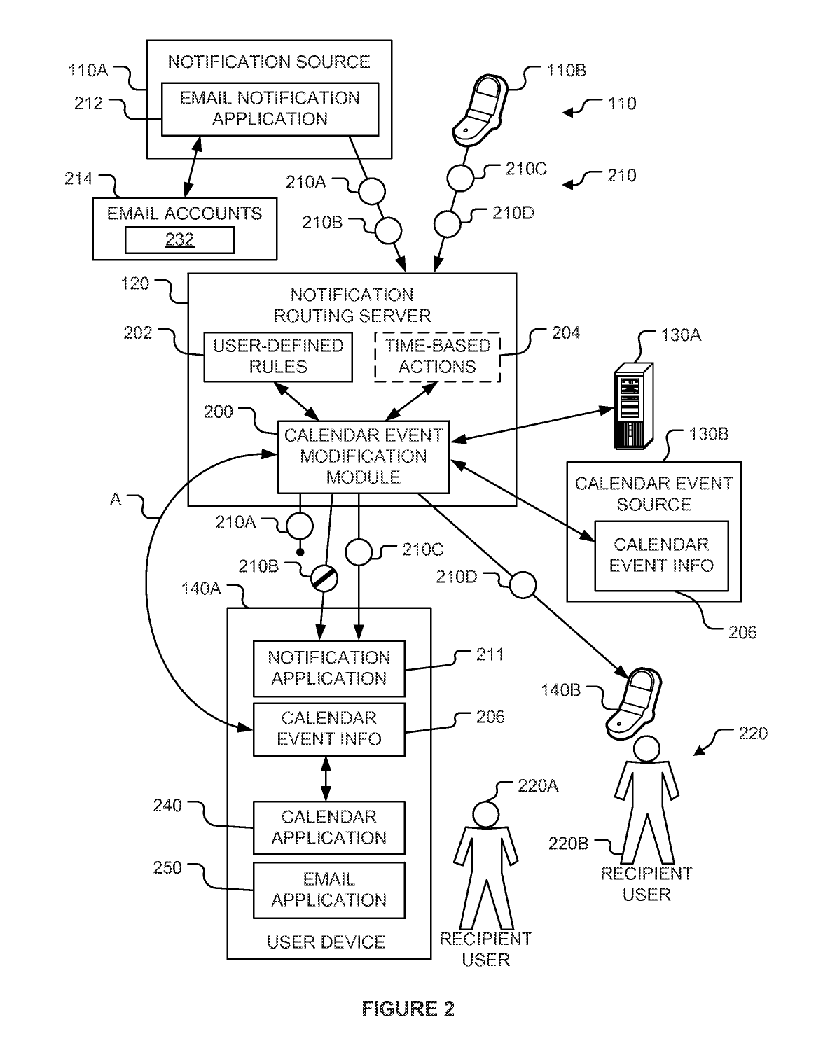

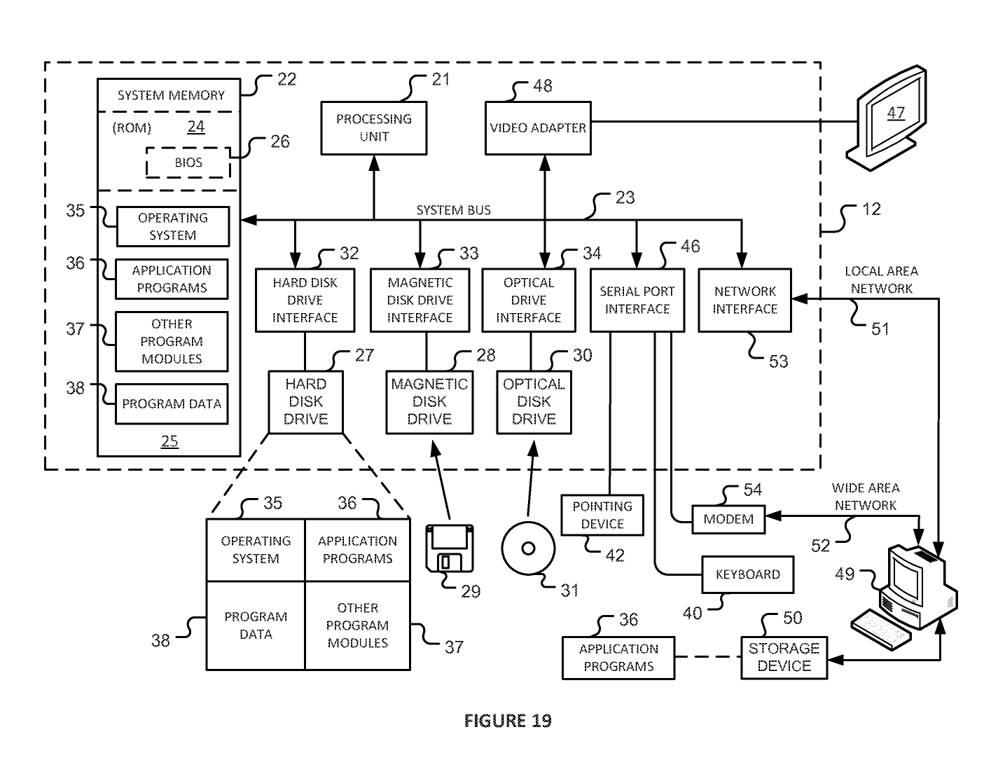

FIG. 1 illustrates a system 100 configured to modify notifications based on calendar events and user-defined rules. FIG. 2 depicts the flow of information through the system 100. Referring to FIG. 1, the system 100 includes one or more notification sources 110, at least one notification routing server 120, one or more calendar event sources 130, and one or more user devices 140. The notification sources 110, the notification routing server 120, the calendar event sources 130, and the user devices 140 are connected to one another by a network 150. Each of the notification sources 110, the notification routing server 120, the calendar event sources 130, and the user devices 140 may be implemented using a computing device 12 illustrated in FIG. 19 and described below.

Turning to FIG. 2, the system 100 includes a calendar event modification module 200. The calendar event modification module 200 may be implemented on the notification routing server 120 and/or a computing device coupled thereto. The calendar event modification module 200 accesses one or more user-defined rules 202 and calendar event information 206 (stored on the calendar event sources 130 and/or the user devices 140) and may optionally create one or more time-based actions 204. The calendar event information 206 used by the calendar event modification module 200 may be provided by multiple different calendar sources. The user-defined rules 202 and the optional time-based actions 204 may be created and stored by the calendar event modification module 200. The user-defined rules 202 and the optional time-based actions 204 may be stored on the notification routing server 120 and/or a computing device coupled thereto.

Each of the notification sources 110 is configured to send notifications 210 to the notification routing server 120. The notifications 210 are intended for a plurality of recipient users 220 each associated with one or more of the user devices 140. In FIG. 2, the recipient users 220 include a first user 220A and a second user 220B. However, as is apparent to those of ordinary skill in the art, the plurality of recipient users 220 may include any number of recipient users. For ease of illustration, the first user 220A will be described as being associated with a user device 140A and the second user 220B will be described as being associated with a user device 140B. By way of non-limiting example, the user device 140A may be implemented as a personal computer (e.g., a desktop computer, a laptop computer, a tablet computer, and the like), and the user device 140B may be implemented as a cellular telephone (e.g., a smart phone).

As mentioned in the Background Section above, notifications include data, short messages, instructions to display dialog boxes, instructions to vibrate, and/or instructions to play sounds. Notifications are intended to inform the recipient users 220 (via the user devices 140) that an event (such as the receipt of a new email, the posting of a new message (e.g., to a website like TWITTER), the receipt of a RSS feed update, the receipt of a text message, the missing of a telephone call, etc.) has occurred.

Each of the user devices 140 includes a conventional notification application 211 configured to receive notifications (e.g., the notifications 210) and in response to each notification, do nothing, generate a display, vibrate, and/or play one or more sounds depending upon the content and type of notification received. Depending upon the implementation details, the notification application 211 executing on some of the user devices 140 may be a component of an operating system 35 (see FIG. 19) executing on the user device. However, this is not a requirement.

In FIG. 2, the notifications 210 sent by the notification sources 110 include four exemplary notifications 210A-210D. The implementation details of each of the notification sources 110 may vary depending on a type of notification being sent by the notification source. In the embodiment illustrated in FIGS. 1 and 2, the notification sources 110 include a computing device 110A and a cellular telephone 110B.

The notifications 210A and 210B are sent by the computing device 110A. Instead of sending the notifications 210A and 210B directly to the user devices 140, the computing device 110A may send the notifications 210A and 210B to the notification routing server 120. By way of non-limiting examples, the notifications 210A and 210B may indicate that a new email has been received, a new message has been posted (e.g., to a website like TWITTER), a RSS feed update has been received, and the like. By way of non-limiting examples, each of the notifications 210A and 210B may include an email message, data, computer-executable instructions, and the like. For ease of illustration, the notifications 210A and 210B will both be described as being intended for the first user 220A and indicating the receipt of a new email.

The computing device 110A may include an email notification application 212 (e.g., a WeNotify application) configured to check one or more email accounts 214 and send the email notifications 210A and 210B to the notification routing server 120 whenever a new email arrives in one of the email accounts 214. Each of the email accounts 214 may be implemented at least in part by the computing device 110A and/or one or more external computing devices (not shown), such as conventional electronic mail servers, that are accessible by the computing device 110A. The email notification application 212 executing on the computing device 110A is provided as a non-limiting example of a notification source for emails. As is apparent to those of ordinary skill in the art, alternate methods may be used to generate notifications and send them to the notification routing server 120.

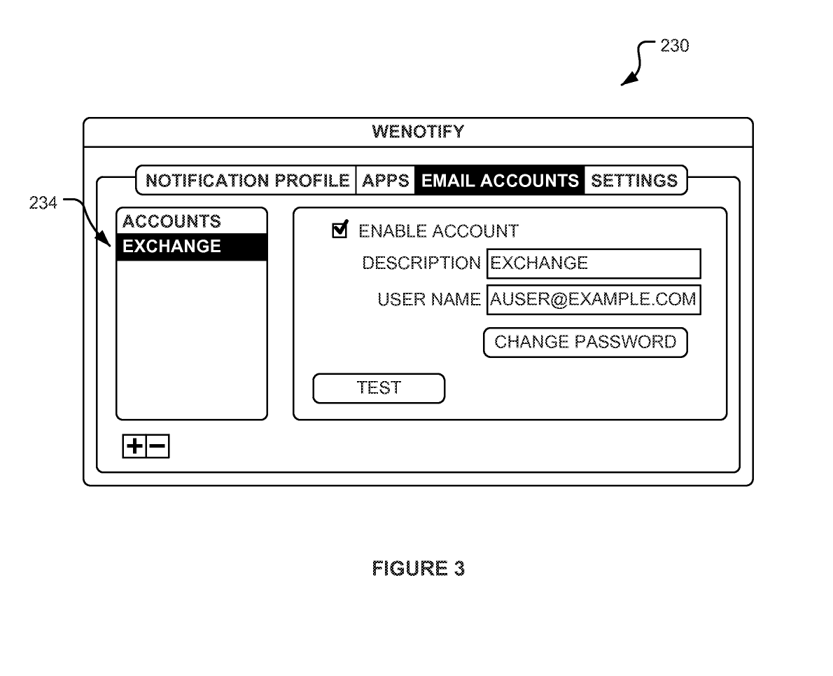

FIG. 3 depicts an exemplary email account screen 230 generated by the email notification application 212. The email account screen 230 may be displayed on the user devices 140 and/or the notification sources 110. The email account screen 230 is used to identify those of the email accounts 214 for which notifications are to be sent to the notification routing server 120. The email account screen 230 displays a listing 234 of the email accounts 214 (see FIG. 2) associated with a particular one of the recipient users 220. In this example, the first user 220A has an email account 232 (see FIG. 2) that is identified by the text “EXCHANGE” in the listing 234. By selecting “ENABLE ACCOUNT” for the email account 232 on the email account screen 230, the email notification application 212 is configured to send notifications to the notification routing server 120 when a new email arrives in the email account 232. For ease of illustration, the notification 210A (sent by the email notification application 212) is a notification of the arrival of a new email sent to the email account 232 intended for the first user 220A. Further, the notification 210A includes the contents and/or a summary of the email message sent to the email account 232.

Returning to FIG. 2, the notifications 210C and 210D are sent by the cellular telephone 110B. Instead of sending the notifications 210C and 210D directly to the user devices 140, the cellular telephone 110B may send the notifications 210C and 210D to the notification routing server 120. By way of non-limiting examples, the notifications 210C and 210D may indicate a new text message has been received, a new email has arrived, a telephone call has been missed, and the like. By way of non-limiting examples, each of the notifications 210A and 210B may include a text message, an indication that a telephone call has been missed, data, computer-executable instructions, and the like. By way of non-limiting example, the notifications 210C and 210D will both be described as indicating the receipt of a new text message with the notification 210C being intended for the first user 220A and the notification 210D being intended for the second user 220B. Further, each of the notifications 210C and 210D includes the text message.

The user devices 140 may each include a conventional calendar application 240 configured to generate and store the calendar event information 206 on the user device and/or the one or more of the calendar event sources 130. The user device 140A (and/or the user device 1408) may store the calendar event information 206 and provide (represented by an arrow “A”) the calendar event information 206 to the calendar event modification module 200 and/or one or more of the calendar event sources 130. The user device 140A may include a conventional email application 250 that may be used by the first user 220A to access the email account 232.

The user devices 140 may each include a conventional web browser (not shown). The email notification application 212, and/or the calendar event modification module 200 may generate a convention web-based user interface displayable by the web browser (not shown). The recipient users 220 may use such web-based user interfaces to configure the email notification application 212, and/or the calendar event modification module 200.

When the notification routing server 120 receives the notifications 210 from the notification sources 110, the calendar event modification module 200 processes the notifications 210. Depending upon the one or more user-defined rules 202, the processing may cause the notification routing server 120 to ignore some of the notifications 210, forward some of the notifications 210 to one or more of the user devices 140, or modify some of the notifications 210 and forward the modified notifications 210 to one or more of the user devices 140. For example, the calendar event modification module 200 ignores (or does not forward) the notification 210A, forwards the notifications 210C to the user device 140A, forwards the notification 210D to the user device 1408, and modifies the notification 210B before forwarding the modified notification 210B to the user device 140A.

To receive notifications from the notification routing server 120, each of the user devices 140 (and/or recipient users 220) may be registered with the notification routing server 120. The registration process may be used to associate each of the recipient users 220 with particular ones of the user devices 140. Further, each of the user devices 140 (and/or recipient users 220) may be associated with particular ones of the calendar event sources 130. Each of the user devices 140 (and/or recipient users 220) may also be associated with particular ones of the notification sources 110.

In the embodiment illustrated in FIGS. 1 and 2, the calendar event sources 130 include a first calendar event source 130A and a second calendar event source 130B. The calendar event sources 130 each store calendar event information 206 accessed by the calendar event modification module 200. In some embodiments, the calendar event information 206 may be stored on one or more of the user devices 140, one or more remote servers (e.g., the calendar event sources 130A and 130B), and/or accessed in other ways. Thus, depending upon the implementation details, one or more of the user devices 140 may be a calendar event source.

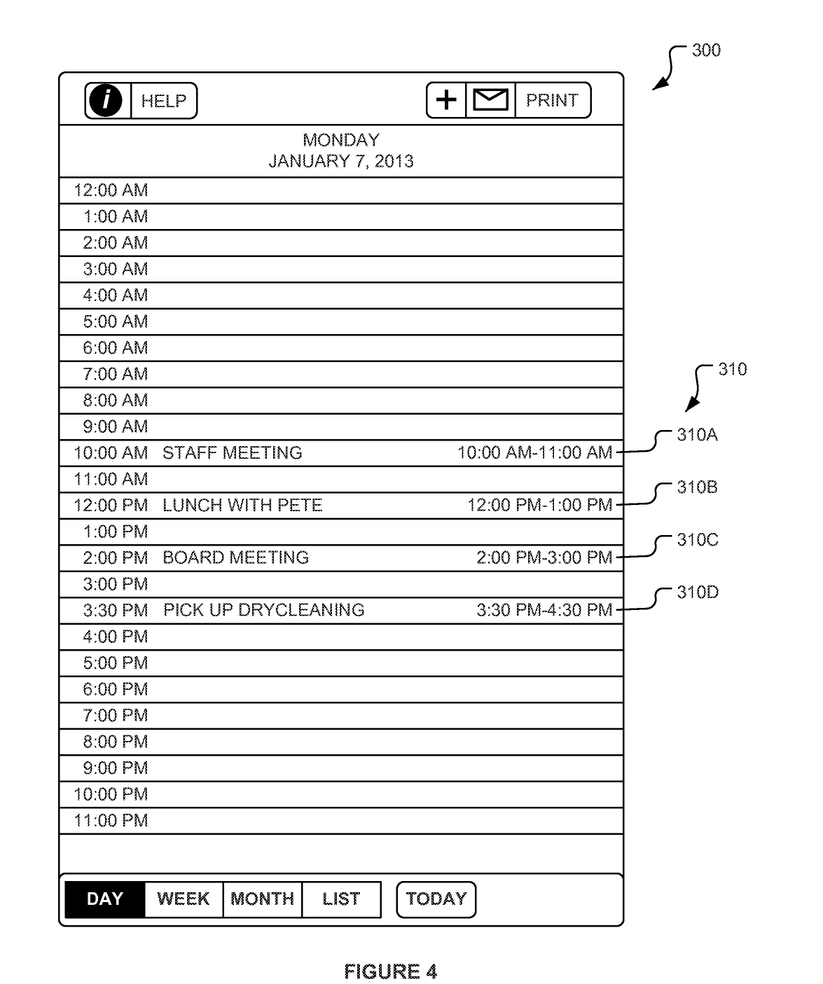

FIG. 4 depicts an exemplary calendar events screen 300. By way of a non-limiting example, the calendar events screen 300 may be generated by the calendar application 240 and displayed by the user device 140A. The calendar events screen 300 illustrated provides some example calendar events stored in or by the calendar application 240 that may be used by the calendar event modification module 200. In the example illustrated, the calendar application 240 may be implemented using a default iPad calendar. However, this is not a requirement. The calendar events screen 300 includes a plurality of exemplary calendar events 310 that includes four calendar events 310A-310D. Each of the calendar events 310 includes one or more calendar event attributes, such as title, notes, start time, end time, location, description, duration, and the like. Further, each of the calendar events 310 has a value for each of the calendar event attributes.

For example, for the calendar event 310A, the value of the calendar event attribute “title” is “STAFF MEETING,” the value of the calendar event attribute “start time” is “Jan. 7, 2013 10:00 AM,” and the value of the calendar event attribute “end time” is “Jan. 7, 2013 11:00 AM.” For the calendar event 310B, the value of the calendar event attribute “title” is “LUNCH WITH PETE,” the value of the calendar event attribute “start time” is “Jan. 7, 2013 12:00 PM,” and the value of the calendar event attribute “end time” is “Jan. 7, 2013 1:00 PM.” For the calendar event 310C, the value of the calendar event attribute “title” is “BOARD MEETING,” the value of the calendar event attribute “start time” is “Jan. 7, 2013 2:00 PM,” and the value of the calendar event attribute “end time” is “Jan. 7, 2013 3:00 PM.” For the calendar event 310D, the value of the calendar event attribute “title” is “PICK UP DRYCLEANING,” the value of the calendar event attribute “start time” is “Jan. 7, 2013 3:30 PM,” and the value of the calendar event attribute “end time” is “Jan. 7, 2013 4:30 PM.”

As mentioned above, the calendar event modification module 200 is used by the notification routing server 120 to modify notification behavior based on a combination of the user-defined rules 202 and the calendar event information 206 stored by the calendar event sources 130 (which may include the user devices 140). In other words, the calendar event modification module 200 applies the user-defined rules 202 to the calendar event information 206 sourced from the calendar event sources 130. In some embodiments, the optional time-based actions 204 are the result. As will be explained below, each of the time-based actions 204 includes one or more user-defined notification actions restricted to within a specific time range.

Optionally, the user-defined rules 202 may be associated with particular ones of the user devices 140 such that some rules apply only to one or more of the user devices 140. For example, each of the user devices 140 may be associated with particular rules that change the notification behavior with respect to that device only. Alternatively, those of the user-defined rules 202 that were created by a particular one of the recipient users 220 may apply to all of the user devices 140 associated with that user.

### Methods

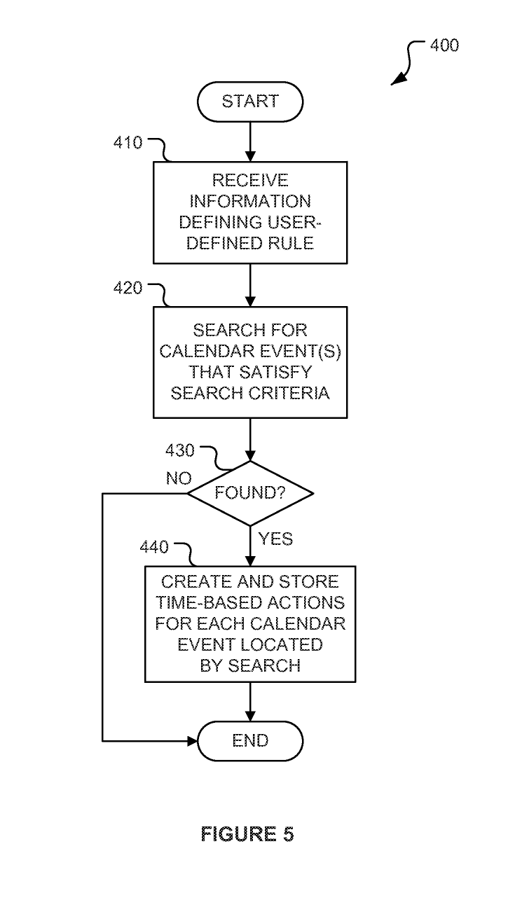

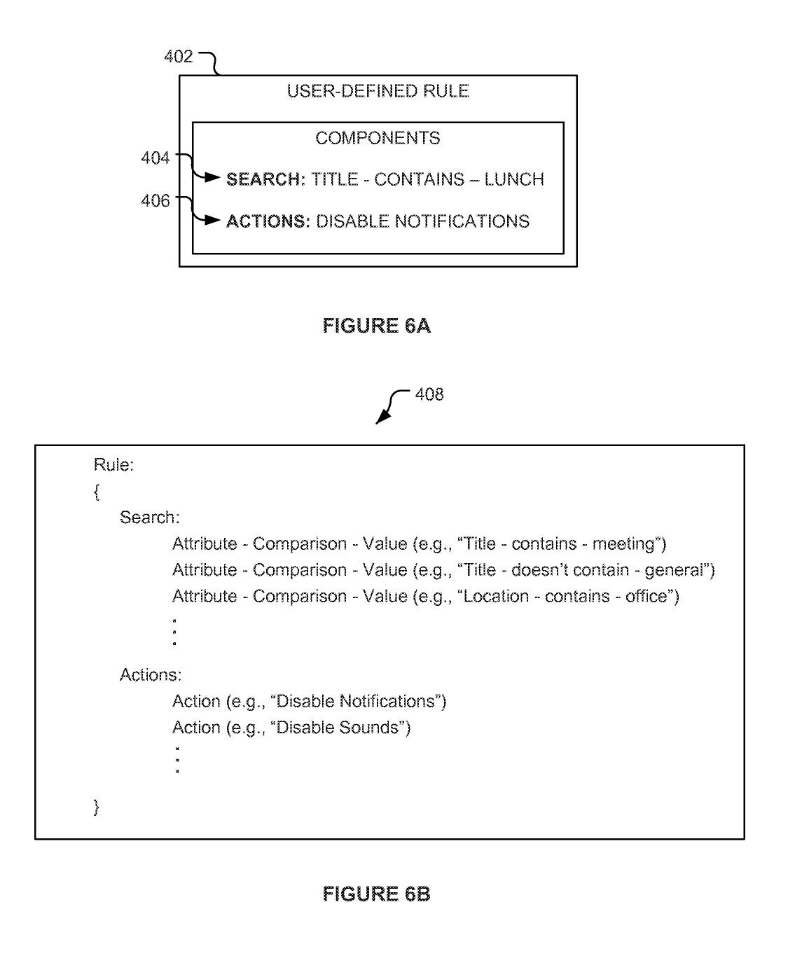

FIG. 5 is a flow diagram of a method 400 that may be performed at least in part by the calendar event modification module 200. In first block 410, the calendar event modification module 200 receives information from the user via one of the user devices 140 defining a new user-defined rule (e.g., a user-defined rule 402 depicted in FIG. 6A). As explained below, the calendar event modification module 200 may generate one or more screens that are displayable on the user devices 140. The recipient users 220 may enter information defining one or more user-defined rules into such screens. This information is then transmitted by the user devices 140 to the calendar event modification module 200, which receives the information in block 410.

Turning to FIG. 6A, the user-defined rule 402 has a search component 404 and an actions component 406. The search component 404 stores search criteria defined by the user that the calendar event modification module 200 may use to find one or more calendar events that satisfy the search criteria. In the example illustrated, the search component 404 stores the search criteria “TITLE—CONTAINS—LUNCH.” This search criteria instructs the calendar event modification module 200 to search for calendar events in which the value of the calendar event attribute “title” includes the term “LUNCH.”

The actions component 406 stores one or more user-defined (or user specified) actions that are performed with respect to a calendar event that satisfies the search criteria. In the example illustrated, the actions component 406 stores the action “DISABLE NOTIFICATIONS,” which instructs the calendar event modification module 200 to disable (or ignore) all notifications (received during any calendar event that has the term “LUNCH” in the value of its calendar event attribute “title”). Examples of other actions that may be applied include playing only a sound without displaying a dialog box, playing a sound, playing a user-defined (or selected) sound, displaying a notification without a sound, and the like.

Each user-defined rule may be stored by the calendar event modification module 200 in a data structure having an exemplary format 408 depicted in FIG. 6B.

Returning to FIG. 5, in block 420, the calendar event modification module 200 searches for any calendar events that satisfy the search criteria of the search component 404. In the example depicted in FIG. 6A, the calendar event modification module 200 searches the calendar events 310 for any calendar events that contain the term “LUNCH” in the value of the calendar event attribute “title.” Thus, referring to the example calendar events 310 depicted in FIG. 4, in block 420, the calendar event modification module 200 would locate the calendar event 310B.

Returning to FIG. 5, in decision block 430, the calendar event modification module 200 determines whether any calendar events were located by the search conducted in block 420. The decision in decision block 430 is “YES” when one or more calendar events where located in block 420. On the other hand, the decision in decision block 430 is “NO” when the search in block 420 did not locate any calendar events. When the decision in decision block 430 is “NO,” the method 400 terminates. When the decision in decision block 430 is “YES,” the calendar event modification module 200 advances to block 440.

In block 440, the calendar event modification module 200 creates and stores one or more time-based actions for each calendar event identified in block 420. Thus, once a calendar event that satisfies the search criteria is found, the calendar event modification module 200 constructs a group of actions (based at least in part on the one or more user-defined actions stored in the actions component 406). Each time-based action has a start time value and an end time value defined by the calendar event that satisfied the search criteria.

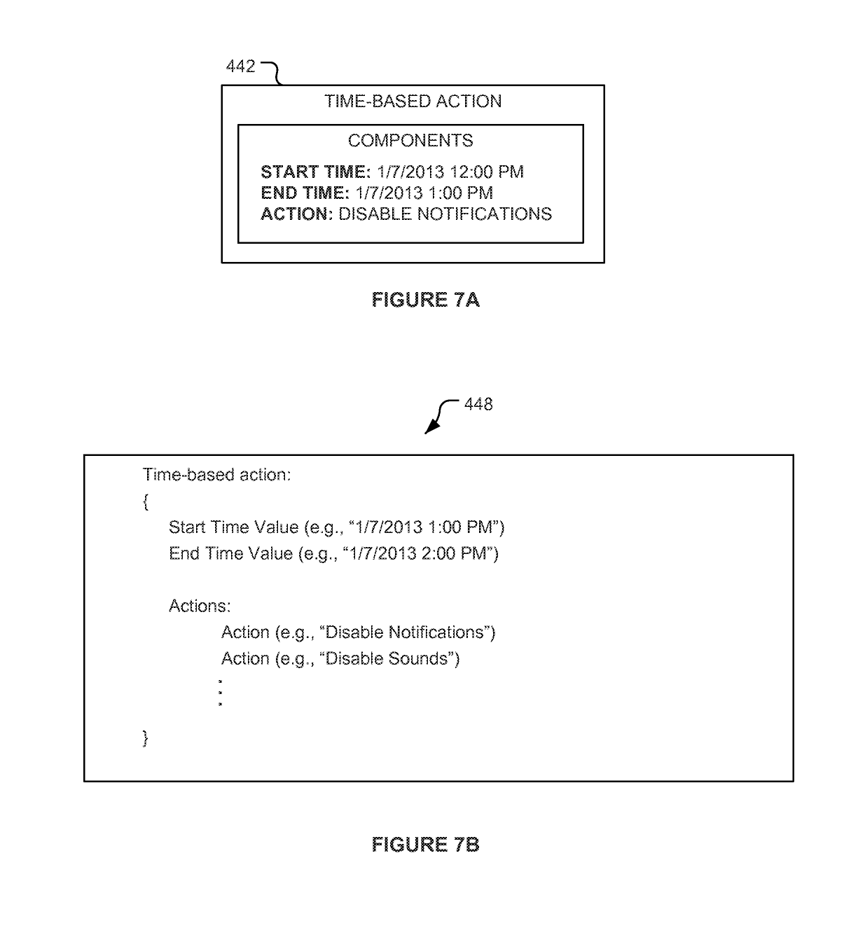

In the example depicted in FIG. 6A, the calendar event modification module 200 searched for calendar events that contain the term “LUNCH” in the value of the calendar event attribute “title.” When a calendar event is found that satisfies this search criteria, the calendar event modification module 200 disables all notifications scheduled to occur or otherwise occurring during the calendar event (i.e., from the value of the calendar event attribute “start time” to the value of the calendar event attribute “end time” of the calendar event). For example, the calendar event 310B (see FIG. 4) includes the term “LUNCH” in the value (“LUNCH WITH PETE”) of its calendar event attribute “title.” Thus, the calendar event 310B satisfies the user-defined rule 402. The calendar event modification module 200 processes the calendar event 310B with the user-defined rule 402, and creates and stores a time-based action 442 depicted in FIG. 7A. The time-based action 442 instructs the calendar event modification module 200 to disable all notifications received from a start time value (“Jan. 7, 2013 12:00 PM”) to an end time value (“Jan. 7, 2013 1:00 PM”).

Each time-based action may be stored by the calendar event modification module 200 using a data structure having an exemplary format 448 depicted in FIG. 7B.

Then, the method 400 terminates.

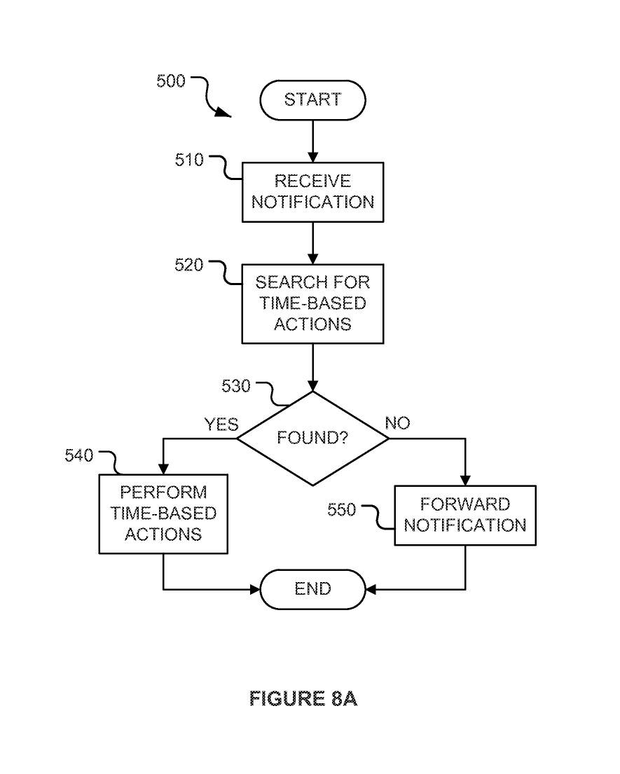

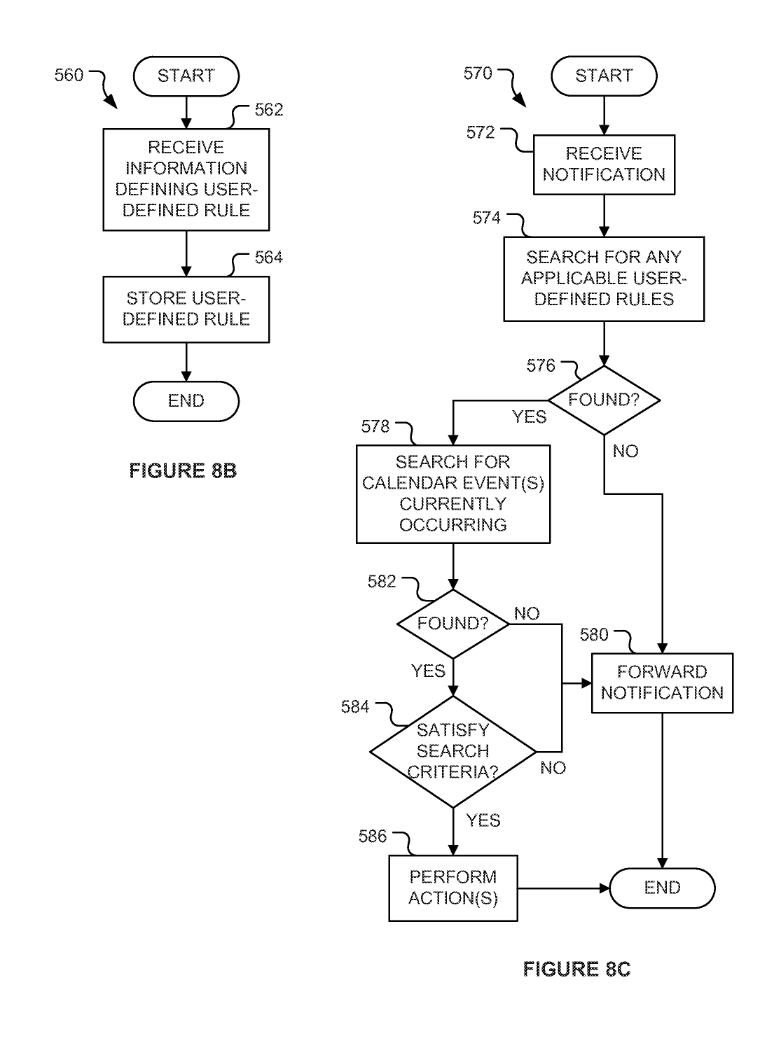

FIG. 8A is a flow diagram of a method 500 that may be performed at least in part by the calendar event modification module 200 whenever the notification routing server 120 receives a notification. In first block 510, the notification routing server 120 receives a notification. For example, the notification routing server 120 may receive the notification 210A (see FIG. 2) in block 510.

In block 520, the calendar event modification module 200 searches the time-based actions 204 for any time-based actions that have a start time value equal to or earlier than the current time that also have an end time value that is equal to or after the current time. In this example, the current time is “Jan. 7, 2013 12:40 PM.” Thus, the start time value (“Jan. 7, 2013 12:00 PM”) of the time-based action 442 depicted in FIG. 7A is earlier than the current time and the end time value (“Jan. 7, 2013 1:00 PM”) of the time-based action 442 is after the current time.

Therefore, in block 520, the calendar event modification module 200 finds the time-based action 442.

Returning to FIG. 8A, in decision block 530, the calendar event modification module 200 determines whether any time-based actions were located by the search conducted in block 520. The decision in decision block 530 is “YES” when one or more time-based actions where located in block 520. On the other hand, the decision in decision block 530 is “NO” when the search in block 520 did not locate any time-based actions. When the decision in decision block 530 is “YES,” the calendar event modification module 200 advances to block 540. When the decision in decision block 530 is “NO,” the calendar event modification module 200 advances to block 550.

In block 540, the calendar event modification module 200 performs the one or more time-based actions located in block 520. In this example, the calendar event modification module 200 performs the time-based action 442, which in this example means the notification routing server 120 ignores the notification 210A depicted in FIG. 2 and does not forward the notification 210A to the user device 140A (see FIG. 1) associated with the first user 220A. Then, the method 500 terminates.

In block 550, the calendar event modification module 200 forwards the notification received in block 510 to one or more of the user devices 140 associated with the intended recipient of the notification. For example, if the notification routing server 120 received the notification 210C (see FIG. 2) in block 510 at 6:00 PM on Jan. 7, 2013, in block 520, no time-based actions would be identified, and the decision in decision block 530 would be “NO.” In this example, in block 550, the calendar event modification module 200 forwards the notification 210C to the user device 140A (see FIG. 2) associated with the first user 220A. Then, the method 500 terminates.

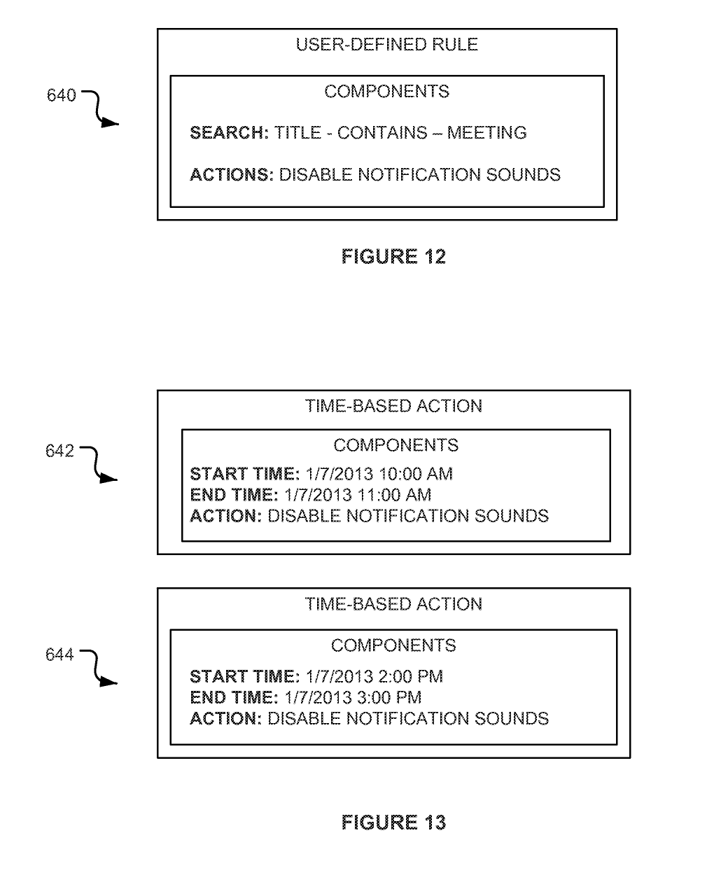

FIGS. 8B and 8C are flow diagrams of methods 560 and 570, respectively that may be performed instead of the methods 400 and 500 (described above and) illustrated in FIGS. 5 and 8A, respectively. Turning to FIG. 8B, the method 560 may be performed at least in part by the calendar event modification module 200. In first block 562, the calendar event modification module 200 receives information from the user via one of the user devices 140 defining a new user-defined rule (e.g., a user-defined rule 640 depicted in FIG. 12). As explained below, the calendar event modification module 200 may generate one or more screens that are displayable on the user devices 140. The recipient users 220 may enter information defining one or more user-defined rules into such screens. This information is then transmitted by the user devices 140 to the calendar event modification module 200, which receives the information in block 562.

In block 564, the calendar event modification module 200 stores the user-defined rule in the user-defined rules 202 (see FIG. 2). By way of a non-limiting example, in block 564, the calendar event modification module 200 may store the user-define rule in a data structure having the exemplary format 408 (depicted in FIG. 6B).

Then, the method 560 terminates.

Turning to FIG. 8C, the method 570 may be performed at least in part by the calendar event modification module 200. In first block 572, the notification routing server 120 (see FIG. 2) receives a notification. For example, the notification routing server 120 may receive the notification 210B (see FIG. 2) in block 572.

In block 574, the calendar event modification module 200 searches the user-defined rules 202 (see FIG. 2) for any user-defined rules that are applicable to the notification. For example, the user-defined rules 202 (see FIG. 2) may include the user-defined rule 402 (see FIG. 6A) and the user-defined rule 640 (see FIG. 12). Therefore, in this example, in block 574, the calendar event modification module 200 locates the user-defined rules 402 and 640.

In decision block 576, the calendar event modification module 200 determines whether any user-defined rules were located by the search conducted in block 574. The decision in decision block 576 is “YES” when one or more user-defined rules where located in block 574. On the other hand, the decision in decision block 576 is “NO” when the search in block 574 did not locate any user-defined rules. When the decision in decision block 576 is “YES,” the calendar event modification module 200 advances to block 578. When the decision in decision block 576 is “NO,” the calendar event modification module 200 advances to block 580.

In block 580, the calendar event modification module 200 forwards the notification received in block 572 to one or more of the user devices 140 associated with the intended recipient of the notification. Then, the method 570 terminates.

In block 578, the calendar event modification module 200 searches for any calendar events that are currently occurring. For example, if the notification 210B (see FIG. 2) was received at 2:15 PM on Jan. 7, 2013, only the calendar event 310C (see FIG. 4) is currently occurring. Thus, the calendar event modification module 200 would locate the calendar event 310C (“BOARD MEETING”) in block 578. On the other hand, if the notification 210B (see FIG. 2) was received at 3:15 PM on Jan. 7, 2013, none of the calendar events 310 (see FIG. 4) are currently occurring. Thus, the calendar event modification module 200 would not locate any calendar event in block 578. Then, the calendar event modification module 200 advances to decision block 582.

In decision block 582, the calendar event modification module 200 determines whether any calendar events were located by the search conducted in block 578. The decision in decision block 582 is “YES” when one or more calendar events where located in block 578. On the other hand, the decision in decision block 582 is “NO” when the search in block 578 did not locate any calendar events. When the decision in decision block 582 is “NO,” the calendar event modification module 200 advances to block 580 (discussed above). When the decision in decision block 582 is “YES,” the calendar event modification module 200 advances to decision block 584.

In decision block 584, the calendar event modification module 200 determines whether any calendar events located in block 587 satisfy the search criteria specified in any of the one or more user-defined rules located in block 574. When the decision in decision block 584 is “NO,” the calendar event modification module 200 advances to block 580 (discussed above). On the other hand, when the decision in decision block 584 is “YES,” the calendar event modification module 200 advances to block 586.

Continuing the example from above, in block 574, the calendar event modification module 200 located the user-defined rules 402 and 640 (see FIGS. 6A and 12). The search criteria of the user-defined rule 402 is “TITLE—CONTAINS—LUNCH” and the search criteria of the user-defined rule 640 is “TITLE—CONTAINS—MEETING.” If for example, in block 578, the calendar event modification module 200 determines the calendar event 310C (see FIG. 4) is currently occurring. In decision block 584, the calendar event modification module 200 determines the calendar event 310 (“BOARD MEETING”) satisfies the user-defined rule 640.

In block 586, the calendar event modification module 200 performs the one or more user-defined actions (in the action component) of each of the one or more user-defined rules located in block 574 that specifies search criteria that is satisfied by one or more of the currently occurring calendar events located in block 578. For example, if the notification 210B (see FIG. 2) was received at 2:15 PM on Jan. 7, 2013, the calendar event 310C (see FIG. 4) is currently occurring. Further, the calendar event 310C satisfies the search criteria of the user-defined rule 640 (see FIG. 12), which was located in block 574. In this example, in block 586, the calendar event modification module 200 performs the user-defined actions (in the action component) of the user-defined rule 640 (see FIG. 12), which specify “DISABLE NOTIFICATION SOUNDS.”

If the search criteria of more than one user-defined rule is satisfied, the calendar event modification module 200 may elect to perform one or more of the user-defined actions associated with these user-defined rules. For example, if a first user-defined rule includes the user-defined action “DISABLE NOTIFICATIONS” and a calendar event satisfying this rule is currently occurring, and at the same time, a second user-defined rule includes the user-defined action “DISABLE NOTIFICATION SOUNDS” and a calendar event satisfying the second user-defined rule is also currently occurring, the calendar event modification module 200 may decide to perform only one of these two user-defined actions. This may be particularly useful if the user-defined actions are contradictory. By way of a non-limiting example, the calendar event modification module 200 may include a hierarchy that ranks available user-defined actions. The calendar event modification module 200 may use the hierarchy to select which of multiple user-defined actions to perform. For example, if “DISABLE NOTIFICATIONS” is ranked more highly than “DISABLE NOTIFICATION SOUNDS” in the hierarchy, the calendar event modification module 200 may choose to “DISABLE NOTIFICATIONS” and not to “DISABLE NOTIFICATION SOUNDS.” Those of ordinary skill in the art appreciate that other methods may be used by the calendar event modification module 200 to select which of multiple user-defined actions to perform and the present disclosure is not limited to use with any methods in particular.

Then, the method 570 terminates.

### User Interface for Creating User-Defined Rules

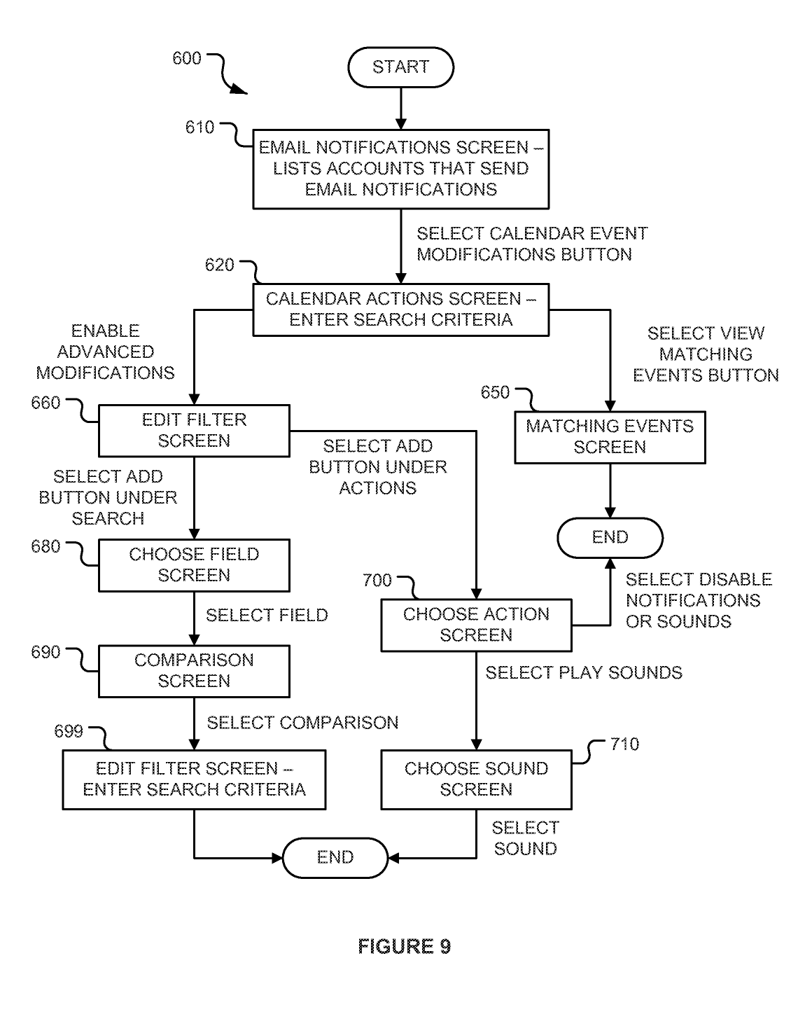

FIG. 9 is a flow diagram 600 illustrating an exemplary order in which a plurality of exemplary user interface screens may be displayed and used to create the user-defined rules 202 (see FIG. 2) for email notifications. Each of these screens may be generated by the calendar event modification module 200 and transmitted to one of the user devices 140 for display thereby to one of the recipient users 220. The recipient users 220 may enter information defining one or more user-defined rules into these screens. This information is then transmitted by the user devices 140 to the calendar event modification module 200, which receives the information in block 410 of the method 400 illustrated in FIG. 5.

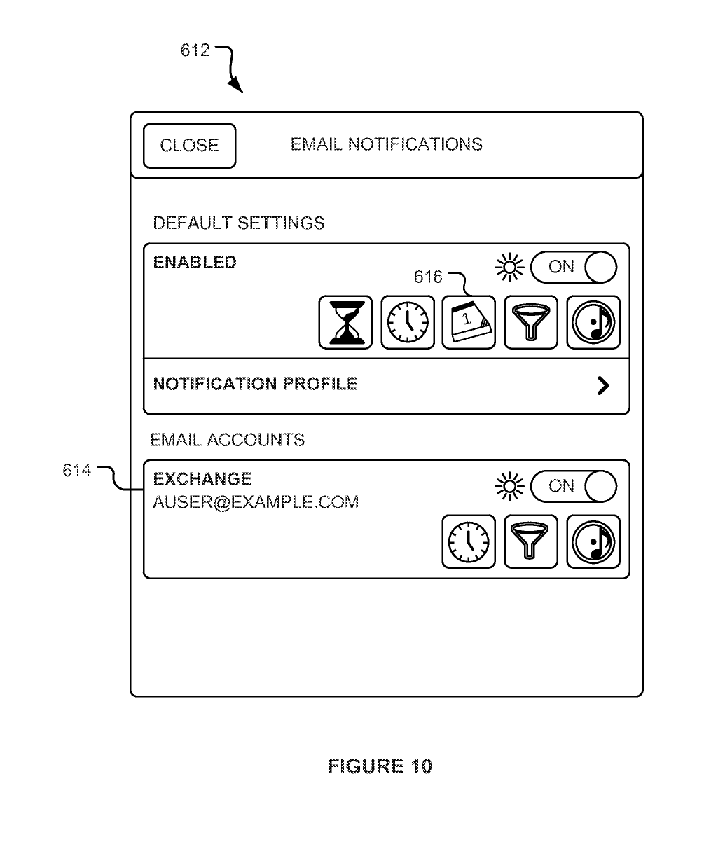

Returning to FIG. 9, in block 610, an email notifications screen is displayed. FIG. 10 depicts an exemplary email notifications screen 612. The email notifications screen 612 may be implemented as an Email Notifications settings screen available on an iPad. The email notifications screen 612 includes an email accounts section 614 that lists each email account that sends email notifications to the user device 140B (via the notification routing server 120). In this example, the email accounts section 614 lists the email account 232 (see FIG. 2) using the text “EXCHANGE.” The email notifications screen 612 includes a selectable calendar event modifications button 616.

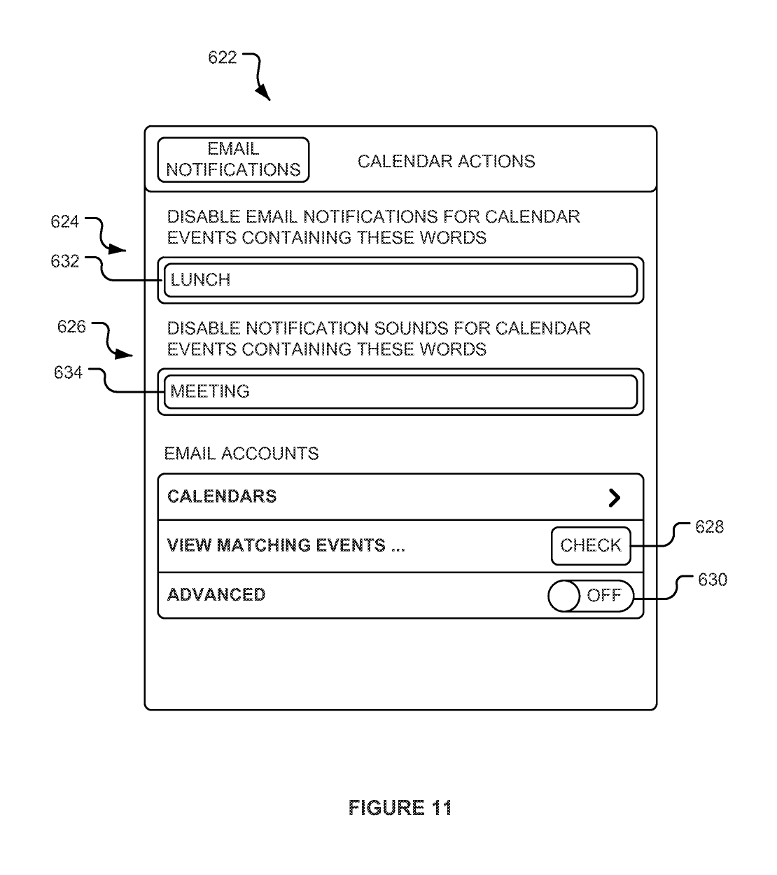

Returning to FIG. 9, after the user selects the calendar event modifications button 616, the calendar event modification module 200 advances to block 620. In block 620, a calendar actions screen is displayed. An exemplary calendar actions screen 622 is depicted in FIG. 11. The calendar actions screen 622 includes a first disable section 624, a second disable section 626, a view matching events button 628, and an advanced modifications user input 630.

The first disable section 624 includes a first search term input 632 into which the user can enter search terms. The calendar event modification module 200 uses these search terms to populate the search component of a user-defined rule. The calendar event modification module 200 automatically populates the actions component with “DISABLE NOTIFICATIONS.” In other words, these search terms provide search criteria that is used to locate calendar events and disable email notifications based on the calendar events located. Thus, the search terms are used to locate and modify email notifications based on calendar events. In the example depicted in FIG. 11, the user has entered the term “LUNCH” in the first search term input 632. By entering the term “LUNCH” as a search word in the first search term input 632, the user has defined the user-defined rule 402 depicted in FIG. 6A that disables all notifications that occur during any calendar events that contain the term “LUNCH” in the value of their calendar event attribute “title.” By way of a non-limiting example and as shown below, this rule may be stored in a data structure having the exemplary format 408 depicted in FIG. 6B:

Rule:
{

Search:

Title - contains - lunch

Actions:

Disable notifications

}

The second disable section 626 includes a second search term input 634 into which the user can enter search terms. The calendar event modification module 200 uses these search terms to populate the search component of a user-defined rule. The calendar event modification module 200 automatically populates the actions component with “DISABLE NOTIFICATION SOUNDS.” Thus, these search terms are used to locate calendar events and disable notification sounds based on the calendar events located. In the example illustrated, the user has chosen to disable notification sounds for the duration of any calendar events containing the word “MEETING.” Thus, the user has created a user-defined rule 640 depicted in FIG. 12 that disables all notification sounds that occur during any calendar events that contain the term “MEETING.” By way of a non-limiting example and as shown below, this rule may be stored in a data structure having the exemplary format 408 depicted in FIG. 6B:

Rule:
{

Search:

Title - contains - meeting

Actions:

Disable notification sounds

}

In block 440 (see FIG. 5) of the method 400, the user-defined rule 640 will cause the calendar event modification module 200 to generate time-based actions 642 and 644 depicted in FIG. 13 based on the calendar events 310A and 310C, respectively, located in block 420. Then, referring to FIG. 2, if the notification 210B is received by the notification routing server 120 at 10:15 AM on Jan. 7, 2013, (in block 540 of the method 500 illustrated in FIG. 8A) the calendar event modification module 200 will perform the time-based action 642 and modify the notification 210B (as illustrated in FIG. 2) to indicate that sounds notifications have been disabled. The notification application 211 of the user device 140A will receive the modified notification 210B and forgo playing a sound in response to having received the modified notification 210B. Nevertheless, the notification application 211 may display a visual indication (and/or vibrate) to indicate to the first user 220A that the modified notification 210B has been received.

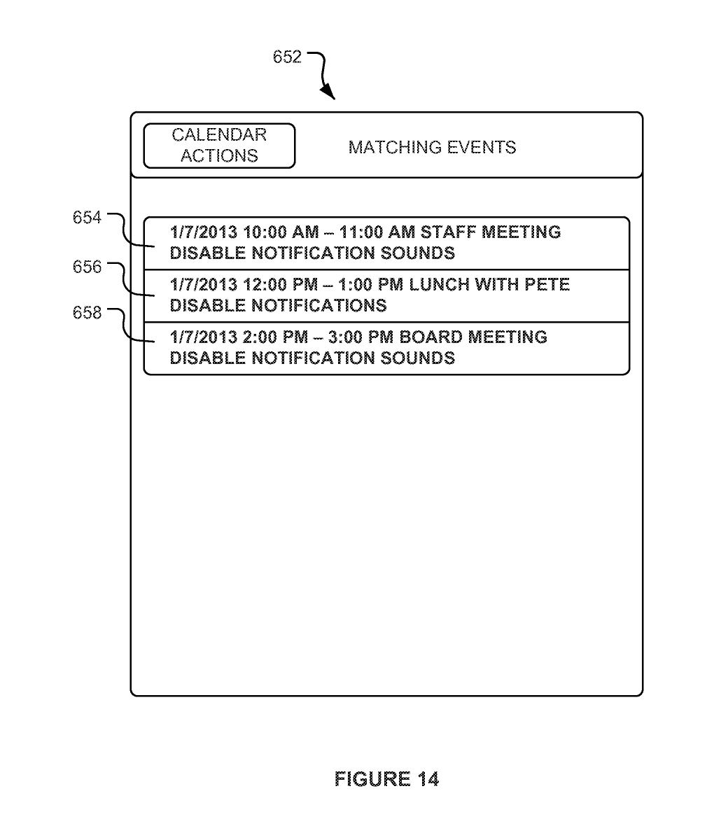

Returning to FIG. 9, after the user selects the view matching events button 628 (see FIG. 11), the calendar event modification module 200 advances to block 650. In block 650, a matching events screen is displayed. FIG. 14 depicts an exemplary matching events screen 652. The matching events screen 652 displays a listing of how the calendar events that satisfy the search criteria entered into the calendar actions screen 622 (see FIG. 11) will modify notifications received during those calendar events. On the matching events screen 652, under each calendar event, each time-based action for the calendar event is displayed. For example, in region 654, the calendar event 310A (see FIG. 4) is displayed above the action “DISABLE NOTIFICATION SOUNDS.” Thus, the region 654 visually displays the calendar event 310A and the time-based action 642 (illustrated in FIG. 13). Further, the calendar event 310B (see FIG. 4) is displayed above the action “DISABLE NOTIFICATIONS” in region 656, and the calendar event 310C (see FIG. 4) is displayed above the action “DISABLE NOTIFICATION SOUNDS” in region 658. Thus, the region 656 visually displays the calendar event 310B and the time-based action 402 (illustrated in FIG. 6A), and the region 658 visually displays the calendar event 310C and the time-based action 644 (illustrated in FIG. 13). The calendar event 310D (see FIG. 4) does not satisfy any of the search criteria entered into the first and second search term inputs 632 and 634 (see FIG. 11). Therefore, the calendar event 310D is not displayed on the matching events screen 652.

Returning to FIG. 9, after the matching events screen 652 is displayed, the user may return to one of the screens discussed above or may terminate the rule defining process.

After the user selects the advanced modifications user input 630 on the calendar actions screen 622 (see FIG. 11), the calendar event modification module 200 advances to block 660.

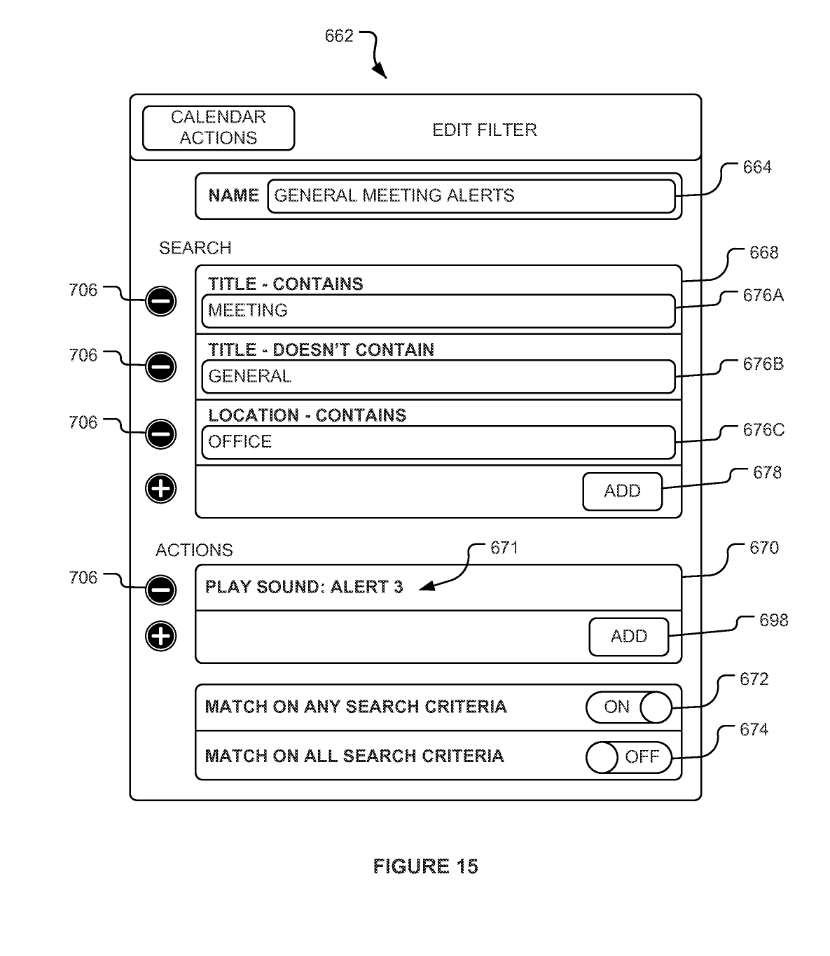

In block 660, an edit filter screen is displayed. FIG. 15 depicts an exemplary edit filter screen 662 that may be used (if the user chooses) to define more complex user-defined rules for modifying notifications with calendar events. The edit filter screen 662 has a name input 664, a search panel 668, an actions panel 670, a match any switch 672, and a match all switch 674. The user may enter a name in the name input 664 to help identify the user-defined rule created using the edit filter screen 662.

The search panel 668 includes one or more search criteria input boxes 676A-676C. Each of the search criteria input boxes 676A-676C is associated with a calendar event attribute and a comparison type. For example, the search criteria input box 676A is associated with the calendar event attribute “title” and the comparison type “contains.” Values entered into the search criteria input box 676A are used to search the value of the associated calendar event attribute based on the comparison type. In the example illustrated, the calendar event modification module 200 would search the values of calendar event attribute “title” for the calendar events 310 (see FIG. 4) to identify any that “contain” the term “MEETING.”

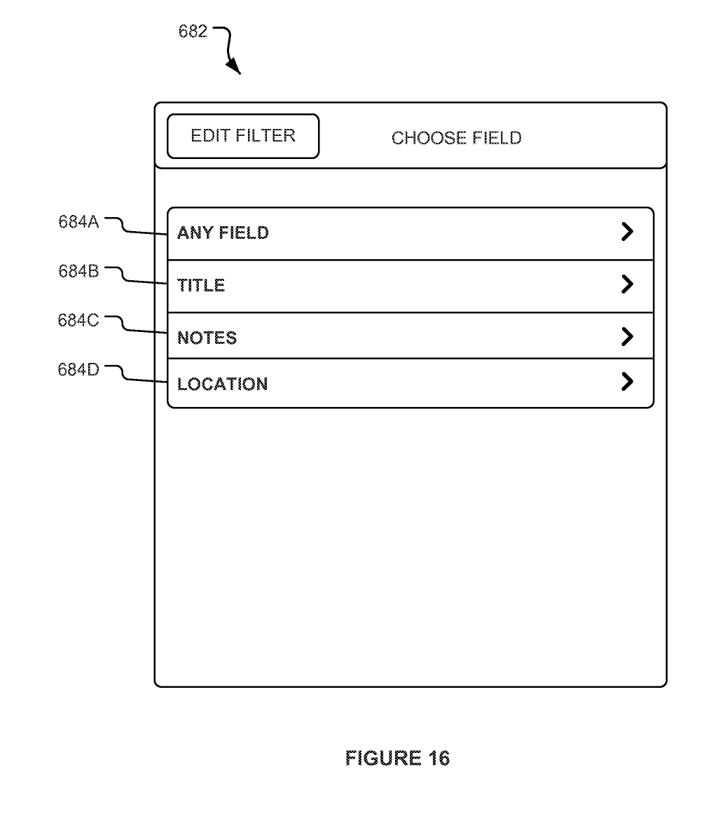

The search panel 668 includes an add button 678. When the add button 678 is selected, the calendar event modification module 200 advances to block 680 (see FIG. 9). Referring to FIG. 9, in block 680, a choose field screen is displayed. FIG. 16 depicts an exemplary choose field screen 682. The choose field screen 682 has a plurality of user inputs 684A-684D each associated with a calendar event attribute or combination of calendar event attributes. By selecting one of the user inputs 684A-684D, the user selects the calendar event attribute or combination of calendar event attributes associated with the user input.

Referring to FIG. 9, after the user selects one of the calendar event attributes or a combination of calendar event attributes, the calendar event modification module 200 advances to block 690.

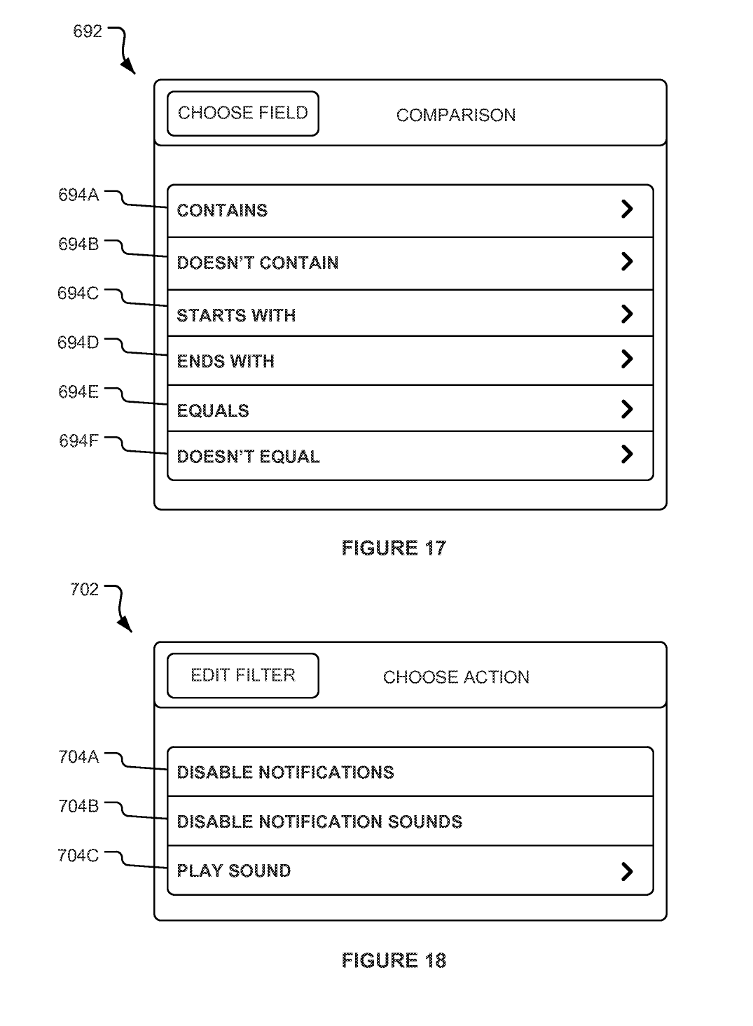

In block 690, a comparison screen is displayed. FIG. 17 depicts an exemplary comparison screen 692. The comparison screen 692 lists a plurality of comparison types 694A-694F that may be selected and used with the selection made on the choose field screen 682 (see FIG. 16).

After the user selects one of the comparison types 694A-694F, in block 699, the user returns to the edit filter screen 662 (see FIG. 15) to enter search criteria for the newly selected calendar event attribute and comparison type pair. By repeatedly selecting calendar event attribute and comparison type pairs and entering search criteria for each pair, the user may “build” the search panel 668 (see FIG. 15) of the edit filter screen 662. Then, the user may return to one of the screens discussed above or may terminate the rule defining process.

In FIG. 15, the user has selected a first pair (associated with the search criteria input box 676A) that includes the calendar event attribute “title” and the comparison type “contains.” Then, the user entered the search criteria “MEETING” to define the following complete search rule: “TITLE CONTAINS MEETING.” This rule will find any calendar event in which the value of the calendar event attribute “title” contains the term “MEETING” and perform the action(s) identified by one or more action selections 671 in the actions panel 670 with respect to any notifications received during any of the calendar events located by the search. In the example illustrated, the action selections 671 include a single action selection “PLAY SOUND: ALERT 3.”

The actions panel 670 includes an add button 698. Returning to FIG. 9, when the add button 698 (see FIG. 15) is selected, the calendar event modification module 200 advances to block 700.

In block 700, a choose action screen is displayed. FIG. 18 depicts an exemplary choose action screen 702. The choose action screen 702 includes one or more selectable action user inputs 704A-704C. Each of the action user inputs 704A-704C is associated with an action. For example, the action user input 704A is associated with the action “DISABLE NOTIFICATIONS,” the action user input 704B is associated with the action “DISABLE NOTIFICATION SOUNDS,” and the action user input 704C is associated with the action “PLAY SOUND.” The action “PLAY SOUND” allows a user to choose a specific sound.

After either the action user input 704A or 704B (associated with the actions “DISABLE NOTIFICATIONS” and “DISABLE NOTIFICATION SOUNDS,” respectively) is selected, a new action selection identifying the action selected is added to the actions panel 670. Then, the user may return to one of the screens discussed above or may terminate the rule defining process.

After the action user input 704C (associated with the action “PLAY SOUND”) is selected, referring to FIG. 9, the calendar event modification module 200 advances to block 710.

In block 710, a choose sound screen (not shown) is displayed. The choose sound screen (not shown) displays a list of sounds from which the user may select. After the user selects a sound, a new action selection (e.g., the action selection “PLAY SOUND: ALERT 3”) identifying both the action and the sound selected is added to the actions panel 670. Then, the user may return to one of the screens discussed above or may terminate the rule defining process.

Returning to FIG. 15, if the user turns “ON” the match any switch 672 of the edit filter screen 662, the calendar event modification module 200 performs the one or more action selections 671 listed in the actions panel 670 when any of the search criteria specified in the search panel 668 is satisfied. Thus, the match any switch 672 may be characterized as enabling an “OR” operation. On the other hand, if the user turns “ON” the match all switch 674, the calendar event modification module 200 performs the one or more action selections 671 listed identified in the actions panel 670 only when all of the search criteria specified in the search panel 668 is satisfied. Thus, the match all switch 674 may be characterized as enabling an “AND” operation. Only one of the switches 672 and 674 may be turned “ON” at a time. Thus, turning “ON” the match any switch 672 may automatically turn “OFF” the match all switch 674. Conversely, turning “ON” the match all switch 674 may automatically turn “OFF” the match any switch 672. In the example illustrated in FIG. 15, the match any switch 672 is turned “ON” and the match all switch 674 is turned “OFF.”

The edit filter screen 662 may include a selectable remove button 706 next to each of the search criteria input boxes 676A-676C and each of the action selections 671. When one of the remove buttons 706 is selected, the search criteria input box or action selection next to the button may be removed (or deleted) from the edit filter screen 662.

The edit filter screen 662 illustrated defines a user-defined rule that may be stored in a data structure having the exemplary format 408 depicted in FIG. 6B:

Rule:
{

Search:

Title - contains - Meeting OR
Title - doesn't contain - General OR
Location - contains - Office

Actions:

Play sound - Alert 3

}

Similar screens to those described above may be used to create the user-defined rules 202 (see FIG. 2) for other types of notifications, such as text message notifications, RSS notifications, missed telephone call notifications, and the like.

### Computing Device

FIG. 19 is a diagram of hardware and an operating environment in conjunction with which implementations of the one or more computing devices of the system 100 may be practiced. The description of FIG. 19 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 19 includes a general-purpose computing device in the form of the computing device 12. Each of the computing devices of FIG. 1 (including the one or more notification sources 110, the notification routing server 120, the one or more calendar event sources 130, and the one or more user devices 140) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 19 include a local-area network (LAN) 51 and a wide-area network (WAN) 52. Such networking environments are commonplace in offices, enterprise-wide computer networks, intranets and the Internet. The network 150 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 400, 500, 560, and 570 illustrated in FIGS. 5, 8A, 8B, and 8C, respectively) described above. Such instructions may be stored on one or more non-transitory computer-readable media.

In some embodiments, the system memory 22 stores computer executable instructions that when executed by one or more processors cause the one or more processors to generate the screens identified in the flow diagram 600 illustrated in FIG. 9 described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method for use with a user computing device, the method being performed by at least one computing device connected to the user computing device by a network, the method comprising:
receiving information identifying search criteria and at least one action from the user computing device over the network, the at least one action instructing the at least one computing device to either ignore notifications intended for the user computing device, or modify notifications intended for the user computing device before forwarding the notifications to the user computing device over the network;
locating one or more calendar events that satisfy the search criteria, each of the one or more calendar events having a scheduled duration;
creating a set of time-based actions comprising a time-based action for each of at least a portion of the one or more calendar events located, each time-based action in the set (a) having a scheduled duration equal to the scheduled duration of the calendar event for which the time-based action was created, and (b) identifying the at least one action;
receiving a notification intended for the user computing device, the notification being associated with a current time;
identifying any of the time-based actions in the set of time-based actions in which the scheduled duration includes the current time; and
for each time-based action identified, based on the at least one action identified by the time-based action, either modifying the notification before forwarding the notification to the user computing device over the network, or ignoring the notification.

2. The method of claim 1, wherein the notification indicates at least one of a receipt of a new email, a receipt of a new text message, a posting of new message, a receipt of an RSS feed update, and a failure to answer a telephone call.

3. The method of claim 1, wherein the at least one action comprises instructions to the at least one computing device to modifying notifications intended for the user computing device such that the notifications cause the user computing device to play a particular sound when the notifications are received.

4. The method of claim 1, wherein the at least one action comprises instructions to the at least one computing device to modifying notifications intended for the user computing device such that the notifications cause the user computing device to forgo playing sounds when the notifications are received.

5. The method of claim 1, wherein locating the one or more calendar events that satisfy the search criteria comprises:
searching calendar event information stored on the user computing device for one or more calendar events that satisfy the search criteria.

6. The method of claim 1 for use with a calendar event source computing device storing calendar event information connected to the at least one computing device by the network, wherein locating the one or more calendar events that satisfy the search criteria comprises:
searching the calendar event information stored on the calendar event source computing device for one or more calendar events that satisfy the search criteria.

7. A computer-implemented method for use with a user computing device and information identifying search criteria and at least one action, the method being performed by at least one computing device connected to the user computing device by a network, the method comprising:
locating one or more calendar events that satisfy the search criteria, each of the one or more calendar events having a start time value and an end time value;
creating a set of time-based actions comprising a time-based action for each of at least a portion of the one or more calendar events located, each time-based action in the set (a) having a start time value equal to the start time value of the calendar event for which the time-based action was created, (b) having an end time value equal to the end time value of the calendar event for which the time-based action was created, and (c) identifying the at least one action, the at least one action instructing the at least one computing device to either ignore notifications intended for the user computing device, or modify notifications intended for the user computing device before forwarding the notifications to the user computing device over the network;
receiving a notification intended for the user computing device, the notification being associated with a current time;
identifying any of the time-based actions in the set of time-based actions in which the start time value of the time-based action is equal to or before the current time and the end time value of the time-based action is equal to or after the current time; and
for each time-based action identified, based on the at least one action, either modifying the notification before forwarding the notification to the user computing device, or ignoring the notification.

8. The method of claim 7, wherein the notification indicates at least one of a receipt of a new email, a receipt of a new text message, a posting of new message, a receipt of an RSS feed update, and a failure to answer a telephone call.

9. The method of claim 7, wherein the at least one action comprises instructions to the at least one computing device to modifying notifications intended for the user computing device such that the notifications cause the user computing device to play a particular sound when the notifications are received.

10. The method of claim 7, wherein the at least one action comprises instructions to the at least one computing device to modifying notifications intended for the user computing device such that the notifications cause the user computing device to forgo playing sounds when the notifications are received.

11. The method of claim 7, wherein locating the one or more calendar events that satisfy the search criteria comprises:
searching calendar event information stored on the user computing device for one or more calendar events that satisfy the search criteria.

12. The method of claim 7 for use with a calendar event source computing device storing calendar event information connected to the at least one computing device by the network, wherein locating the one or more calendar events that satisfy the search criteria comprises:
searching the calendar event information stored on the calendar event source computing device for one or more calendar events that satisfy the search criteria.

13. A computer-implemented method for use with a plurality of user computing devices and a plurality of notification sources, the method being performed by at least one computing device connected to the plurality of user computing devices and the plurality of notification sources by a network, the at least one computing device storing a plurality of time-based actions each associated with one or more of the plurality of user computing devices, each of the plurality of time-based actions being in effect over a scheduled duration and comprising an action that either (a) instructs the at least one computing device to ignore notifications that are received during the scheduled duration and intended for the one or more of the plurality of user computing devices associated with the time-based action, or (b) modify notifications that are received during the scheduled duration and intended for the one or more of the plurality of user computing devices associated with the time-based action before forwarding the modified notifications to the one or more of the plurality of user computing devices associated with the time-based action, the method comprising:
receiving a plurality of notifications from the plurality of notification sources, each notification being intended for at least one of the plurality of user devices, each notification being associated with a current time; and
for each of the plurality of notifications:
(a) searching the plurality of time-based actions for any time-based actions that are both (i) in effect at the current time associated with the notification, and (ii) associated with the at least one of the plurality of user devices for which the notification is intended, and
(b) for each time-based action located by the search, based on the action of the time-based action, either ignoring the notification or modifying the notification and forwarding the modified notification to the at least one of the plurality of user devices for which the notification was intended.

14. The method of claim 13, wherein each of the plurality of notifications indicates at least one of a receipt of a new email, a receipt of a new text message, a posting of new message, a receipt of an RSS feed update, and a failure to answer a telephone call.

15. A computer-implemented method for use with a user computing device, the method being performed by at least one computing device connected to the user computing device by a network, the method comprising:
receiving a notification intended for the user computing device;
obtaining information identifying search criteria and at least one action, the at least one action instructing the at least one computing device to either ignore notifications intended for the user computing device, or modify notifications intended for the user computing device before forwarding the notifications to the user computing device over the network;
locating one or more currently occurring calendar events; and
performing the at least one action if any of the one or more currently occurring calendar events satisfies the search criteria.
